(19) United States
(12) Patent Application Publication
(10) Pub. No.: US 2020/0346945 A1
(43) Pub. Date: Nov. 5, 2020

(54) Gas Flotation Water Treatment System and Flow Straightener Therefore

(71) Applicant: SUEZ GROUPE, Paris La Defense (FR)

(72) Inventors: Hugo Lessard, Levis (CA); Reneau Dufour, Levis (CA); Yannick Banaszak, Quebec (CA)

(73) Assignee: SUEZ GROUPE, Paris La Defense (FR)

(21) Appl. No.: 16/758,976

(22) PCT Filed: Dec. 19, 2018
(86) PCT No.: PCT/EP2018/086004

§ 371 Date: Apr. 24, 2020

(30) Foreign Application Priority Data
Dec. 20, 2017 (CA) 298985.3

(51) Int. Cl. C02F 1/24; B03D 1/14

(52) U.S. Cl. CPC C02F 1/24; B03D 1/1412; B03D 1/1431; C02F 2301/022; B03D 1/1475; B03D 1/1493; B03D 1/1456

(57) ABSTRACT

The water treatment system can have a tank having an elongated shape with two opposite ends and two transversally opposite sides; a flocculation chamber at one of the opposite ends of the tank, the flocculation chamber having at least one treated water inlet and a mixer and a separation chamber adjacent to the flocculation chamber inside the tank, the separation chamber having at least one treated water outlet. A flow straightener system can be provided having a transversally-oriented wall forming an overflow baffle and extending upwardly between the flocculation chamber and the separation chamber, the transversally-oriented wall having an upper edge and a plurality of vanes being vertically and longitudinally oriented, parallel to one another and transversally interspaced from one another along the upper edge of the wall, the vanes extending in at least one of the two transversally opposite sides of the tank.

### BACKGROUND

Gas flotation is used in a number of water treatment processes, particularly in industrial water treatment processes used in a wide variety of industrial applications such as oil refineries, petrochemical and chemical plants, natural gas processing plants, and paper mills to name a few examples.

Gas flotation typically involves a first process step of coagulation/flocculation in which a chemical coagulation agent is added into the water. The coagulation agent has the role of favoring the agglomeration of colloids, which are suspended in the water, into larger particles referred to as flocs. Typical flocculation involves mixing to uniformize the distribution of the coagulation agent in the water. Subsequently, microbubbles of gas are attached to the flocs to increase their buoyancy, and bring the flocs to the surface where a skimming system can be used to remove them from the water. Some systems are further adapted to allow heavier impurities to settle/sediment, and be gathered in the form of sludge.

In many industrial applications, the size of the water treatment system, or footprint, is a concern, and there is thus a strong incentive to produce a design which is compact while achieving satisfactory efficiency. While known systems were satisfactory to a certain degree, there always remains room for improvement.

### SUMMARY

There is provided a gas flotation water treatment system which can be integrated into a single, relatively compact, tank. The tank can generally have a rectangular prism shape having a longitudinal orientation corresponding to its length. A flocculation chamber can be provided at a first end of the tank, where a water feed is received from an inlet. The flocculation chamber can have a mixer system for flocculation efficiency. The tank can further have a separation chamber downstream of the flocculation chamber, in which gas flotation and separation of the flocs are performed. The flocculation chamber/separation chamber sequence can be oriented longitudinally. The separation chamber can have a plurality of inclined plates to increase dwell time of the flocs, and favor their contact with the microbubbles for flotation. A skimming system can be used to skim the floating flocs from the surface. As the water enters via the flocculation chamber, and exits via the separation chamber, the flocculation chamber can be said to be upstream of the separation chamber relative to the general flow of the water. Microbubbles can be introduced at an upstream end of the separation chamber, which can be achieved by using a plurality of transversally-interspaced nozzles configured to form a curtain of microbubbles. In a dissolved gas flotation approach, the microbubbles of gas (e.g. air, nitrogen, natural gas, or another suitable gas depending on the application) are initially dissolved into a portion of the treated water exiting the system, and form as the treated water is reintroduced into the tank and the pressure is lowered. Gas may alternately be introduced directly in the water in some applications.

In a typical application, the rotation speed of the mixer directly affects the amount of dwell time in the flocculation chamber and to flocculation efficiency. Indeed, the vortex caused by the mixer typically brings the particles along a helical path, and increasing the rotation speed increases the number of rotations which the average particles perform around the mixer's axis before being freed into the separation chamber, across the microbubble curtain. A sufficient amount of dwell time is required for satisfactory formation of the flocs on average, and accordingly, a corresponding minimal mixer rotation speed may be required. One challenge in achieving a small footprint is that it if the separation chamber is positioned close to the flocculation chamber, the vortex flow can exceed the bounds of the flocculation chamber, and draw some of the microbubbles into the vortex, rather than proceeding along the separation chamber and inclined plates, and they thus tend to be wasted because the flocs are not sufficiently formed at that stage. Separating the flocculation chamber from the separation chamber addresses this problem, but has the inconvenience of causing a larger footprint. Separating the flocculation chamber from the separation chamber by an overflow baffle extending above the fluid level in the separation chamber also addressed this problem, but presented the inconvenience of generating turbulence as the water cascaded into the separation chamber. The turbulence was found to break the flocs and was thus ultimately found counterproductive in some applications. Indeed, the flocs are relatively fragile, and the passage of the flow between the flocculation chamber and the separation chamber should be designed in a manner to handle the flocs delicately, and avoid breaking them down.

A solution which is applicable to some embodiments was provided in the form of a flow straightener system used to “straighten” the flow (i.e. forcing it out of the circumferential vortex mode into a lengthwise mode along the length of the separation chamber) over a relatively short distance between the flocculation chamber and the separation chamber. It was found that in some embodiments, this approach could limit the inconveniences associated to microbubbles being drawn into the vortex while handling the flocs sufficiently delicately to limit breakage and being performed over a relatively small distance associated to a limited footprint.

Indeed, in order to favor a compact construction, a transversally-oriented wall can be provided between the separation chamber and the flocculation chamber and used as an overflow baffle, forming a transition fluid passage between an upper edge of the wall and the water level, in which the flow of fluid is guided. A flow straightener system can be provided in the transition fluid passage, below the level of fluid. The flow straightener system can include a plurality of vanes being vertically and generally longitudinally oriented, parallel to one another, and transversally interspaced from one another along the upper edge of the wall, in one, or both, transversal halves of the tank (opposite facing vanes in opposite halves of the tank can allow a symmetrical construction, adapted to either mixer angular rotation orientation, for instance). The vanes can have a front portion projecting upstream of the wall, and a rear portion projecting downstream of the wall. The front portion of the vanes can be inclined relative to the rear portion of the vanes relative to a vertical axis (i.e. sloping to a side), into the circumferential orientation of arrival of the fluid. The rear portion of the vanes can further project downwardly relative to the height of the upper edge of the wall, which can assist in limiting turbulences which could be undesirable in some embodiments. Microbubbles of flotation gas can be introduced in an upstream portion of the separation chamber, adjacent the wall, in a manner for microbubbles to reach the downstream area of the vanes.

Accordingly, in accordance with one aspect, there is provided a water treatment system comprising a tank having an elongated shape with two opposite ends and two transversally opposite sides; a flocculation chamber at one end, the flocculation chamber having at least one treated water inlet and a mixer; a separation chamber adjacent to the flocculation chamber, the separation chamber having at least one treated water outlet; a transversally-oriented wall forming overflow baffle extending upwardly between the flocculation chamber and the separation chamber, the transversally-oriented wall having an upper edge; a transition fluid passage extending between the upper edge of the wall and the water level; a plurality of vanes being vertically and longitudinally oriented, parallel to one another and transversally interspaced from one another along the upper edge of the wall in at least one of the two transversally opposite sides of the tank and extending in the transition fluid passage.

Preferably, the vanes can have a longitudinally-oriented rear portion extending downstream of the wall, and a front portion projecting upstream of the wall. The front portions can be laterally inclined relative to corresponding rear portions, into the orientation of incoming water during use, and the rear portions project downwardly relative to the height of the upper edge of the wall.

Preferably, vanes can be provided on both opposite sides of the tank, and the front portions of the vanes of on each side of the tank can be inclined towards a corresponding lateral wall of the tank, allowing straightening of the flow of water independently of the angular orientation of the mixer.

Preferably, the separation chamber has an inclined plate clarifier including a plurality of adjacent, parallel, transversally oriented inclined plates, a skimming system configured to skim the surface of the water at the water level, and the at least one outlet is below the level of the inclined plates.

Preferably, the separation chamber has a dissolved gas system including a line receiving a portion of treated water from the at least one outlet, a system to introduce pressurized gas into the portion of treated water, and plurality of nozzles to reintroduce the portion of treated water, with the pressurized gas, in an upstream portion of the separation chamber.

In accordance with another aspect, there is provided a flow straightener system for an elongated tank of a water treatment system having a flocculation chamber and a separation chamber, the flow straightener system comprising a transversally-oriented wall having an upper edge, and a plurality of vanes being vertically and longitudinally oriented, parallel to one another and transversally interspaced from one another along the upper edge of the wall in at least one of the two transversally opposite sides of the tank.

In accordance with still another aspect, there is provided a method of treating water including dissolved gas flotation, the method comprising: feeding water having suspended colloids and coagulant into a flocculation chamber, mixing the water and coagulant in the flocculation chamber to form flocs, transiting the water with flocs into a separation chamber including straightening a flow of said water and flocs, separating the flocs from the water in the separation chamber and drawing the separated water out of the separation chamber.

It will be noted that in some industries, air will be used as the gas in the dissolved gas flotation system, whereas in others, nitrogen or another gas can be preferred. While the expression dissolved air flotation system (air) is sometimes used in the art as distinct from the expression dissolved gas flotation system (other gasses), this distinction will not be made herein and the expression dissolved gas flotation will be used as encompassing either air or any other suitable gas as the flotation medium. Similarly, some applications can prefer to use induced gas in lieu of, or as a supplement to, dissolved gas as a flotation medium. The expression gas flotation will be used herein as encompassing both the dissolved gas and the induced gas approaches, or any combination thereof.

Many further features and combinations thereof concerning the present improvements will appear to those skilled in the art following a reading of the instant disclosure.

### DESCRIPTION OF THE FIGURES

In the figures,

FIG. 1 is an oblique view of an example of a gas flotation water treatment system;

FIG. 2 is an oblique view showing the simulated path of microbubbles in the gas flotation water treatment system of FIG. 1 with a mixer speed of 1.5 RPM;

FIG. 3 is an oblique view showing the simulated path of microbubbles in the gas flotation treatment system of FIG. 1 with a mixer speed of 4.5 RPM;

FIG. 4 is an oblique view showing the simulated path of microbubbles in a gas flotation treatment tank differing from the gas flotation treatment tank of FIG. 1 in that if further includes a flow straightener, with a mixer speed of 4.5 RPM;

FIG. 5 is an oblique view showing another example of a gas flotation water treatment system;

FIG. 6 is an enlarged view showing a portion of FIG. 5

FIG. 7 is a side elevation view of a flow straightener in the partial environmental context of the gas flotation treatment tank of FIG. 5;

FIG. 8 is a top plan view of a flow straightener in the partial environmental context of the gas flotation treatment tank of FIG. 5;

FIG. 9 is an enlarged view showing a portion of FIG. 8.

### DETAILED DESCRIPTION

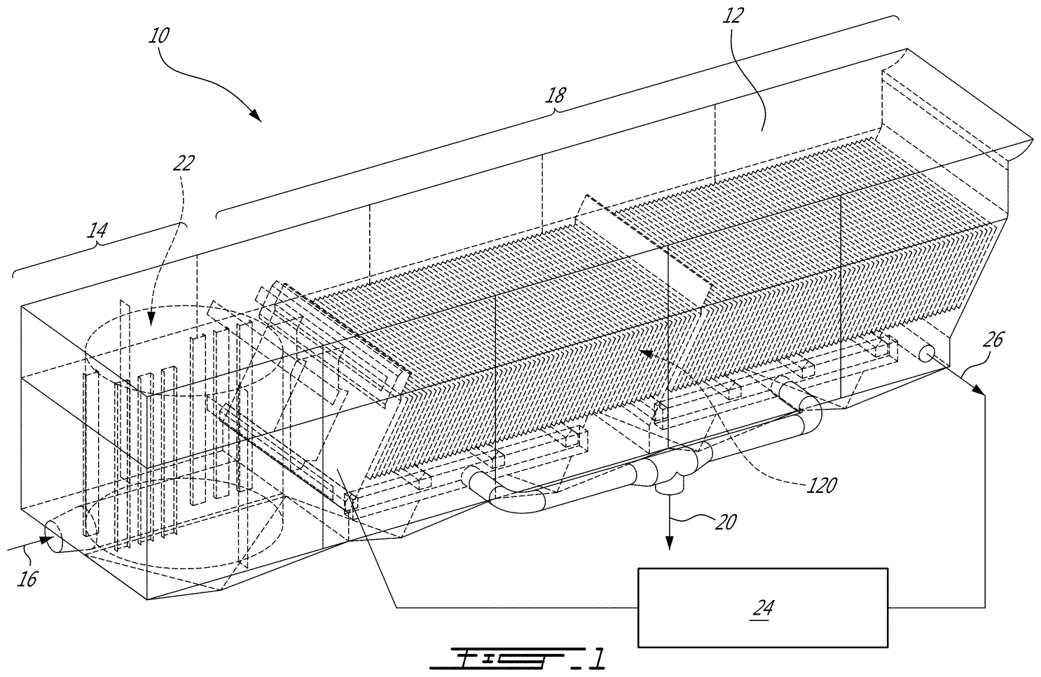

FIG. 1 shows an example of a dissolved gas flotation water treatment system 10. The water treatment system 10 generally has a tank 12 having an elongated, rectangular parallelepiped shape with two longitudinally opposite ends and two transversally opposite sides. The tank has a flocculation chamber 14 at one end. A water inlet 16 leads into the flocculation chamber 14. A separation chamber 18 is provided downstream to the flocculation chamber 14, adjacent thereto. The separation chamber 18 has at least one treated water outlet 20 from which the treated water is extracted.

During use, a coagulant is introduced into the flocculation chamber 14 with the water which has colloids in suspension. A mixer 22 having blades rotating around a vertical axis is operated to favour the mixing of the coagulant with the colloids, to favor the formation of flocs. The speed of rotation of the blades can be adjusted in a manner to obtain a satisfactory floc formation when the water exits the flocculation chamber 14 and transits to the separation chamber 18. In this example, microbubbles of gas are introduced into an upstream portion of the separation chamber 18, agglomerate with the flocs, and work to bring the flocs to the surface, where they can be skimmed. More specifically, a portion of the treated water is extracted into a recirculation loop which is provided with a system 24 to introduce pressurized gas which dissolves into the portion of treated water. The recirculation loop is directed to a plurality of transversally interspaced nozzles provided at the upstream portion of the separation chamber 18. Upon exiting the nozzles, the pressure of the fluid lowers to the pressure in the tank, and microbubbles of the dissolved gas are formed. In this example, simulating the processing of water in the oil and gas industry, the dissolved gas was nitrogen.

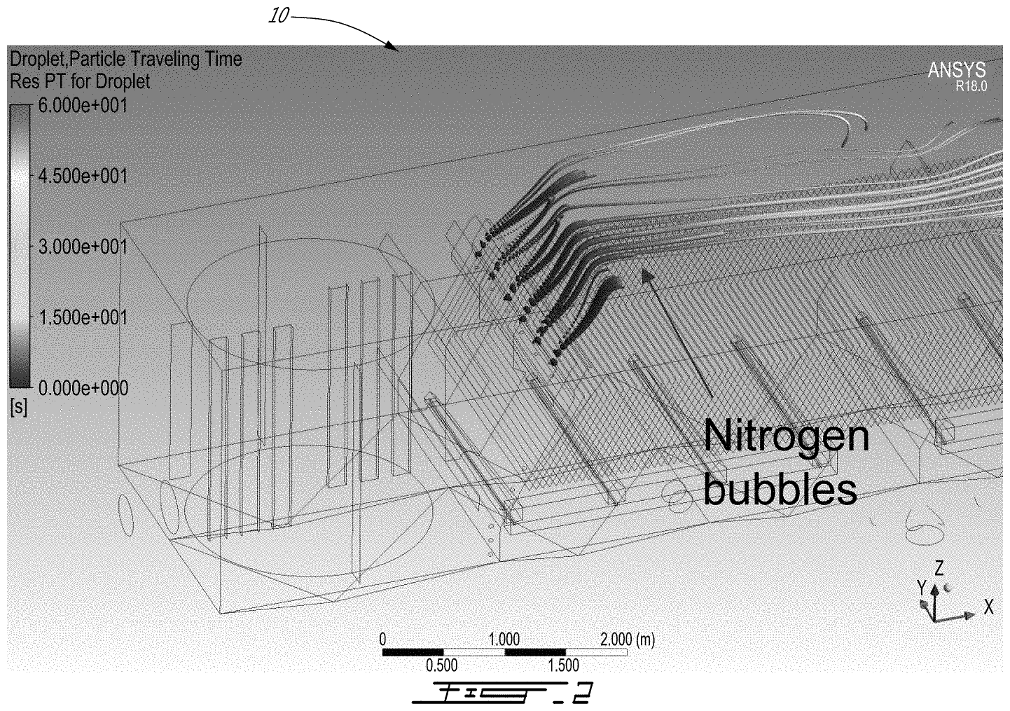

FIG. 2 shows a curtain of microbubbles which are introduced in the upstream portion of the separation chamber 18. More specifically, FIG. 2 illustrates the results of a computational fluid dynamics (CFD) simulation showing the flow of the microbubbles when the mixer 22 is rotated at 1.5 RPM. This simulation was conducted at an inlet flow of 500 GPM, a recirculation flow 26 (FIG. 1) treated by a Poseipump™ (see U.S. Pat. Nos. 5,385,442 and 5,779,439) gas introduction device operated at 3150 RPM with 2 SCFM of Nitrogen or a recirculation flow 26 of 200 GPM and a discharge at 82-83 psig. The CFD software is ANSYS CFX™, the fluid is water at ambient temperature, a steady state simulation was performed with a shear stress transport turbulence model. Two domains were modeled, a rotating model in the flocculation chamber 14, and a stationary model in the separator. The nitrogen bubbles were modeled using Lagrangian bubble particles (one way coupling) with a mean microbubble diameter of 40 microns. A Rosin Rammler particle diameter distribution was used. The mesh was made denser at the interface between the flocculation chamber and the separation chamber 18. As shown in FIG. 2, which shows a 60 second simulation, the flow of microbubbles for a mixer rotation speed of 1.5 RPM was mostly longitudinal (aligned with the length of the tank), and thus satisfactory.

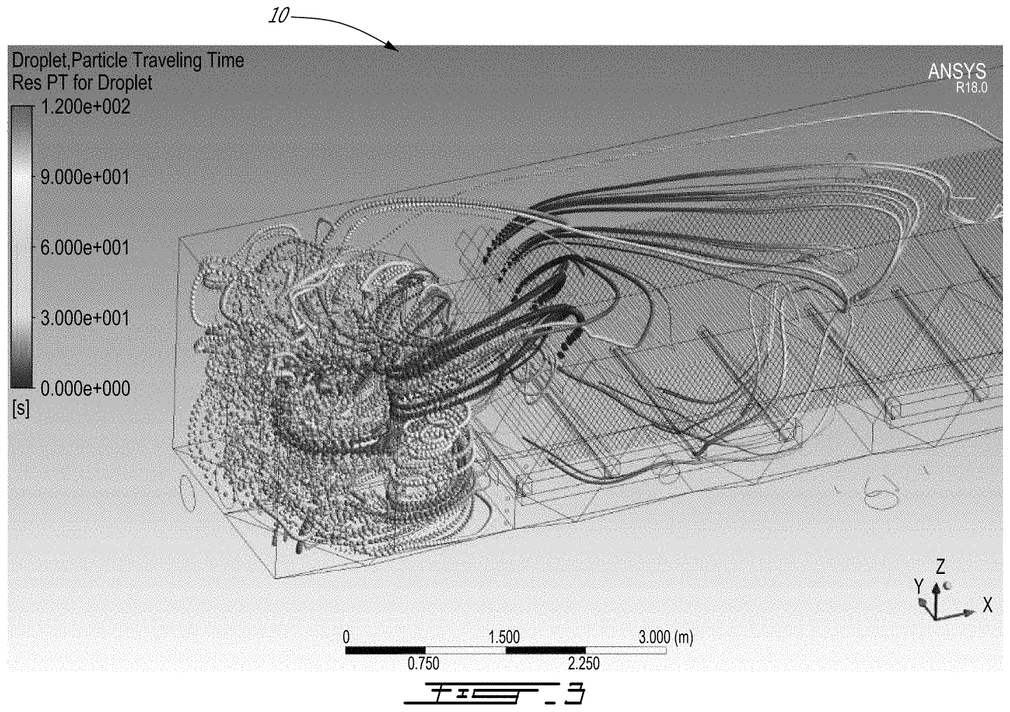

However, when the mixer rotation speed was increased to 4.5 RPM, a flow shown at FIG. 3 was obtained over a 120 second simulation. The flow can be seen to be significantly disturbed by the vortex stemming from the higher rotational speed of the mixer 22. The simulation indicated that roughly 66% of the microbubbles were drawn into the flocculation chamber, which was found to sufficiently disrupt the proper flotation function so as to be considered unsatisfactory for the desired application.

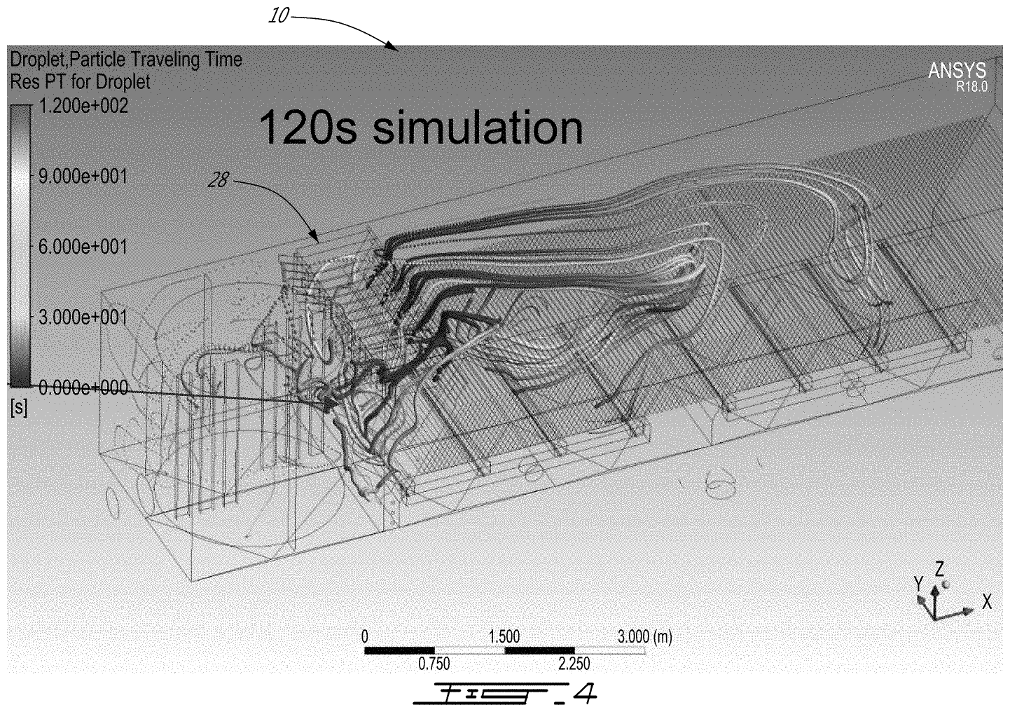

A passive flow straightener 28 was introduced into the model between the flocculation chamber and the separation chamber 18, such as shown in FIG. 4. The simulation with the flow straightener 28 was also conducted for a mixer speed of 4.5 RPM over 120 seconds. The simulation indicated that the flow straightener 28 reduced the amount of microbubbles being drawn into the vortex to less than 8%, which was found satisfactory for the desired application.

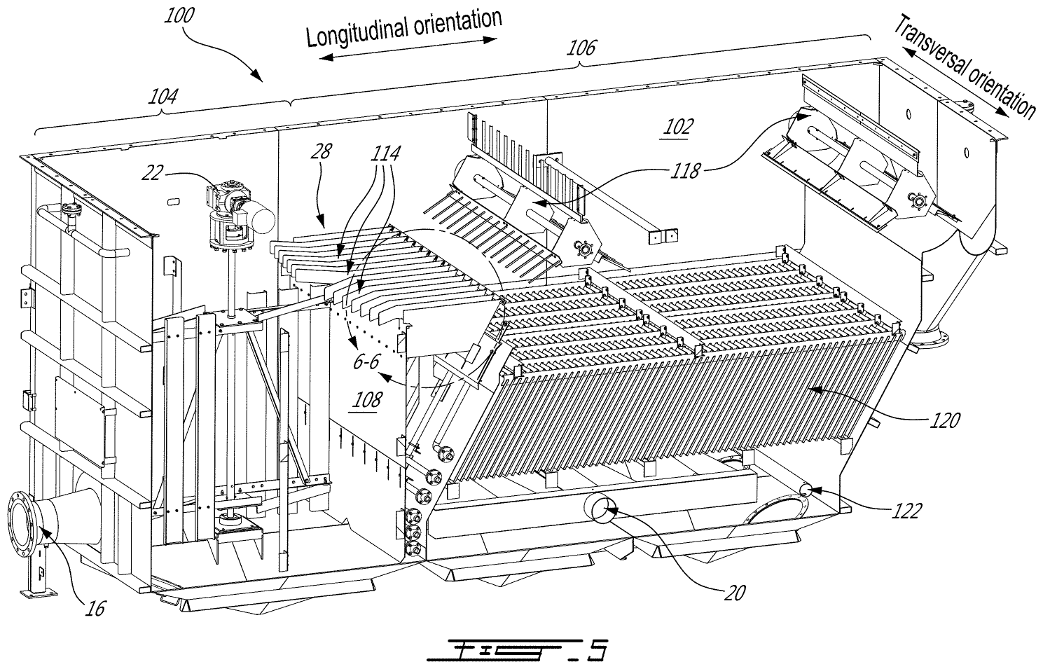

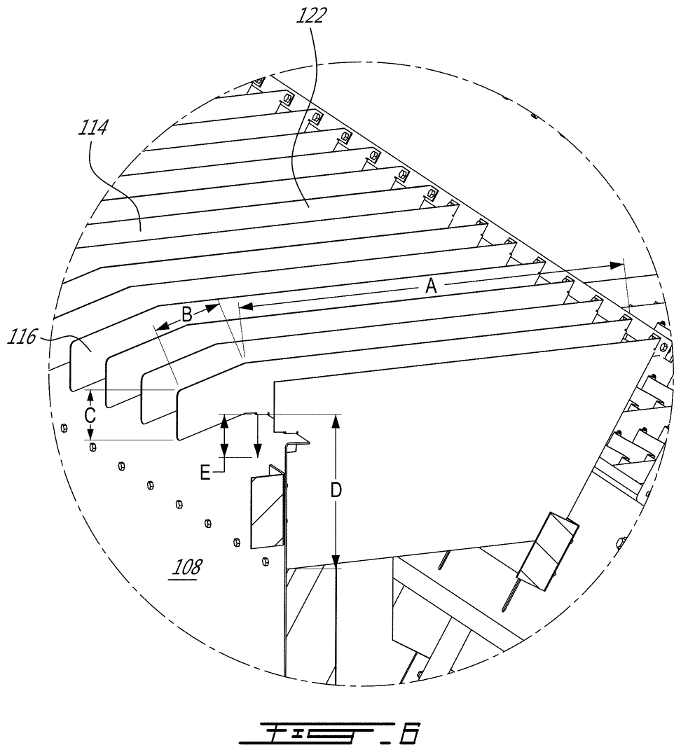

Another example of a water treatment system 100 is presented in FIG. 5, having the flow straightener 28 which was tested in the simulation illustrated in FIG. 4. Additional views of this gas flotation treatment tank 100, and of the flow straightener 28, are presented in FIGS. 6 to 9.

As best seen in FIG. 5, this water treatment system 100 also has a tank 102 having a flocculation chamber 104 and a separation chamber 106, but the separation chamber 106 is shorter than the separation chamber 18 of the embodiment shown in FIG. 1. Indeed, in alternate embodiments, the width and length of the tank 102 can vary depending on the designed process parameters.

The flow straightener 28 includes a transversally-oriented wall 108 acting as an overflow baffle. The wall 108 extends upwardly between the flocculation chamber 104 and the separation chamber 106, and has an upper edge 110. A transition fluid passage can be said to extend vertically between the upper edge 110 of the wall 108 and the water level 112. The flow straightener 28 further has a plurality of vanes 114 which are parallel to one another and transversally interspaced from one another along the upper edge 110 of the wall 108. The vanes 114 are positioned in the transition fluid passage, on both transversally opposite sides of the tank 102. It will be understood from the description below that in an alternate embodiment, it can be preferred to position the vanes 114 only on one lateral side of the tank 102, but in this embodiment, it was preferred to use a symmetrical design to allow the flow straightener 28 to operate similarly independently of the angular orientation of the mixer movement. The vanes 114 can be said to be both vertically and longitudinally oriented, even though it will be noticed that in this embodiment, a front portion 116 of the vanes 114 is inclined laterally towards the closest lateral wall of the tank 102 (into the orientation of the partially circumferential incoming flow of fluid).

FIG. 5 also shows the mixer 22, the skimming system 118, the inclined plate clarifier 120, the recirculation outlet 122 leading to the nozzles 126 via the gas introduction system (not shown), the water inlet 16 and the treated water outlet 20. During operation, water having suspended colloids and coagulant are fed into the flocculation chamber 104, where the water and coagulant are mixed and form flocs; the flow of the water and flocs is straightened during the transit into the separation chamber 106, and the flocs are separated from the water in the separation chamber 106, where the separated water is drawn out of the separation chamber 106. The flocs can be skimmed from the surface. More specifically, microbubbles are introduced in an upstream portion of the separation chamber 106. The microbubbles tend to adhere to flocs when brought into contact therewith. Having a sufficient concentration of microbubbles, and a sufficient amount of time during which the microbubbles can potentially come into contact with flocs can thus favour the contact between the microbubbles and the flocs. The inclined plates of the inclined plate clarifier 120 artificially increase the amount of possible contact time for a given footprint.

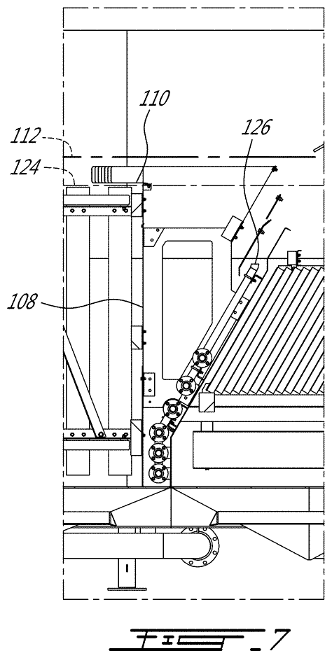

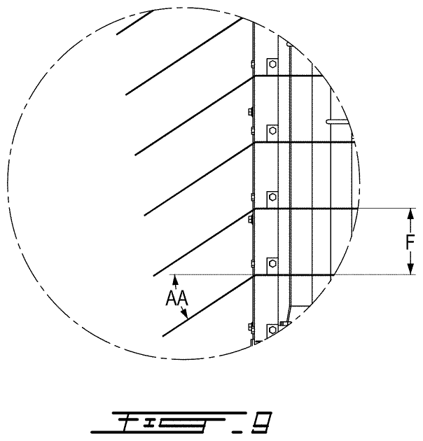

Referring to FIG. 6 where the vanes 114 are shown enlarged, the vanes 114 can be seen to include a planar rear portion 122 extending downstream of the wall 108 and which is longitudinally oriented, and a planar front portion 116 extending upstream of the wall 108, and which is inclined laterally relative to the planar rear portion 122 over angle AA (see FIG. 9). As best seen in FIG. 7, in this embodiment, the rear portions 122 project downwardly relative to the height 124 of the upper edge 110 of the wall 108, which was found to limit the formation of undesired turbulence downstream of the wall 108. Moreover, the upper edge of the vanes 114 was designed to extend slightly below the water level in a manner to reduce the exposure of the vanes 114 which flocs which may have accumulated at the surface.

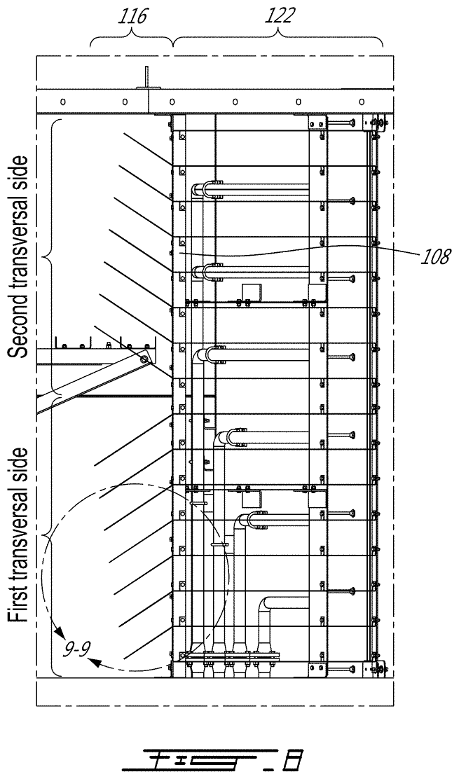

FIGS. 8 and 9 show the relative length of the front portion 116 and rear portion 122 relative to the size of the tank 102. It will be noted that in this embodiment, the length of the front portion 116 was selected to progressively increase from one vane to another, between a corresponding side wall of the tank 102 and the transversal centerline of the tank 102. This was found satisfactory for the intended application. A total of 7 vanes 114 were used on each side, with an eighth vane without a front portion 116 also being provided adjacent the corresponding side wall.

It will be understood that the amount of vanes 114, and various dimensions and configurations thereof, can vary in alternate embodiments, depending on the size of the tank 102, the feed rate of water and the height of the water transit passage, among other considerations.

Table 1, presented below, presents example ranges, and example preferred ranges, for various parameters A-F and AA as identified in FIGS. 6 and 9:

TABLE 1
example ranges and example preferred ranges for vane parameters

| | | Example range | | | | Example pref. range | | | |
|---|---|---|---|---|---|---|---|---|---|
| | | min | | max | | min | | max | |
| Parameter | | in | cm | in | cm | in | cm | in | cm |
| A | in/cm | 6 | 15 | 120 | 305 | 12 | 30 | 48 | 122 |
| B | in/cm | 2 | 5 | 40 | 102 | 6 | 15 | 18 | 46 |
| C | in/cm | 2 | 5 | 20 | 51 | 3 | 7 | 6 | 16 |
| D | in/cm | 0 | 0 | 60 | 153 | 6 | 15 | 18 | 46 |
| E | in/cm | 0 | 0 | 60 | 153 | 0 | 0 | 2 | 6 |
| F | in/cm | 1 | 2 | 30 | 77 | 2 | 5 | 12 | 31 |

| | | | | | |
|---|---|---|---|---|---|
| AA | deg | 10 | 60 | 25 | 45 |

For greater clarity, A is the length of the rear portion 122, B is the length of the front portion 116, C is the height of the front portion 116 and rear portion 122 above the height 124 of the upper edge 110 of the wall 108, D is the height along which the rear portion 122 protrudes downwardly from the height 124 of the upper edge 110 of the wall 108, E is the height along which the front portion 116 may protrude downwardly from the height 124 of the upper edge 110 of the wall 108, F is the spacing between the vanes 114, and more specifically between the rear portion 122 thereof, and AA is the angle of lateral inclination of the front portion 116 relative to the rear portion 122. The quantity of vanes 114 used on a given lateral side of the tank 102 can vary depending on the width of the tank 102, as a function of the values of vane interspacing F as presented above.

As can be understood, the examples described above and illustrated are intended to be exemplary only. The scope is indicated by the appended claims.

What is claimed is:

1. A water treatment system comprising: a tank having an elongated shape with two opposite ends and two transversally opposite sides; a flocculation chamber at one of the opposite ends of the tank, the flocculation chamber having at least one treated water inlet and a mixer; a separation chamber adjacent to the flocculation chamber inside the tank, the separation chamber having at least one treated water outlet; a transversally-oriented wall forming an overflow baffle and extending upwardly between the flocculation chamber and the separation chamber, the transversally-oriented wall having an upper edge; a transition fluid passage extending between the upper edge of the wall and a water level in the tank; a plurality of vanes being vertically and longitudinally oriented, parallel to one another and transversally interspaced from one another along the upper edge of the wall, the vanes extending in the transition fluid passage in at least one of the two transversally opposite sides of the tank.

2. The water treatment system of claim 1 wherein the vanes have a longitudinally-oriented rear portion extending downstream of the wall, and a front portion projecting upstream of the wall.

3. The water treatment system of claim 2 wherein the front portions are each laterally inclined relative to the corresponding rear portion, into partially circumferential orientation of incoming water flow.

4. The water treatment system of claim 2 wherein the rear portions project downwardly relative to the height of the upper edge of the wall.

5. The water treatment system of claim 2 wherein the vanes are provided on both of said transversally opposite sides of the tank, and the front portions of the vanes of on each side of the tank are inclined towards a corresponding lateral wall of the tank.

6. The water treatment system of claim 2 wherein the front portion of a vane proximate a lateral edge of the wall is shorter than the front portion of a van proximate a transversal centerline of the tank, and wherein the length of the front portions of vanes intermediate to the vane proximate the lateral edge and the vane proximate to the transversal centerline increases progressively from the vane proximate the lateral edge to the vane proximate to the transversal centerline.

7. The water treatment system of claim 1 wherein the separation chamber has an inclined plate clarifier including a plurality of adjacent, parallel, transversally oriented inclined plates, and a skimming system configured to skim the surface of the water at the water level, and the at least one outlet is below the level of the inclined plates.

8. The water treatment system of claim 1 wherein the separation chamber has a dissolved gas system including a line receiving a portion of treated water from the at least one outlet, a system to introduce pressurized gas into the portion of treated water, and plurality of nozzles positioned in an upstream portion of the separation chamber for reintroducing the portion of treated water with the pressurized gas therein.

9. The water treatment system of claim 1 wherein the mixer has a single rotor having a plurality of vertically-extending blades and being drivable into rotation around a vertical axis.

10. A flow straightener system for an elongated tank of a gas flotation water treatment system, the flow straightener system comprising: a planar wall having an upper edge, and a plurality of vanes projecting from the upper edge of the planar wall and being oriented normal to the wall, parallel to one another and transversally interspaced from one another along the upper edge of the wall in at least one of two halves of the wall.

11. The flow straightener system of claim 10 wherein the wall has an upstream face and a downstream face, the vanes have a longitudinally-oriented rear portion extending downstream of the wall, and a front portion projecting upstream of the wall.

12. The flow straightener system of claim 11 wherein the front portions are each inclined relative to the corresponding rear portion in the orientation of the wall.

13. The flow straightener system of claim 11 wherein the rear portions project downwardly relative to the upper edge of the wall.

14. The flow straightener system of claim 11 wherein the wall has two opposite lateral edges, the vanes are provided on both of said halves of the wall, and the front portions of the vanes of on each half of the wall are inclined outwardly towards a corresponding lateral edge of the wall.

15. The flow straightener system of claim 11 wherein the front portion of a vane proximate a lateral edge of the wall is shorter than the front portion of a van proximate a center of the wall, and wherein the length of the front portions of vanes intermediate to the vane proximate the lateral edge and the vane proximate to the center increases progressively from the vane proximate the lateral edge to the vane proximate to the center.

16. A method of treating water comprising: feeding water having suspended colloids and coagulant into a flocculation chamber, mixing the water and coagulant in the flocculation chamber to form flocs, transiting the water with flocs into a separation chamber including straightening a flow of said water and flocs, separating the flocs from the water in the separation chamber and drawing the separated water out of the separation chamber.

17. The method of treating water of claim 16 wherein said straightening includes receiving an partially circumferentially-oriented and partially longitudinally-oriented incoming flow of water and flocs with front portions of vanes, the front portions being oriented into the orientation of the incoming flow of water and flocs, and said straightening further includes guiding the flow of water and flocs with longitudinally-oriented rear portions of vanes downstream of the corresponding front portions.
